(19) United States
(12) Patent Application Publication
(10) Pub. No.: US 2023/0259267 A1
(43) Pub. Date: Aug. 17, 2023

(54) SYSTEM AND METHOD FOR DISPLAY ON-SCREEN DISPLAY (OSD) NAVIGATION BY KEYBOARD AND MOUSE

(71) Applicant: Dell Products, L.P., Round Rock, TX (US)

(72) Inventors: Bee June Tye, Singapore (SG); Peng Lip Goh, Singapore (SG); Lei Guo, Singapore (SG)

(73) Assignee: Dell Products, L.P., Round Rock, TX (US)

(21) Appl. No.: 17/650,729

(22) Filed: Feb. 11, 2022

(51) Int. Cl. G06F 3/0487; G06F 3/04847

(52) U.S. Cl. CPC G06F 3/0487; G06F 3/04847

(57) ABSTRACT

System and method for displaying On-Screen Display (OSD) navigation by keyboard and mouse are described. In some embodiments, an Information Handling System (IHS) may include a processor and a memory coupled to the processor, the memory having program instructions stored thereon that, upon execution by the processor, cause the IHS to: receive a mouse command from a mouse, and determine that the mouse command is associated with an OSD that is generated by a display. In response to the determination, the instructions generate an OSD-based command that is associated with the mouse command, and transmit the OSD-based command to an OSD controller, wherein the OSD controller is configured to implement at least one setting change of the OSD based on the OSD-based command.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Interaction with an IHS is typically accomplished with a display which may also be referred to as a monitor. In many current displays, in order to adjust parameters of a display to implement specific visual effects, a user usually needs to use physical buttons of the display to control an On-Screen-Display (OSD) menu of the display. Nevertheless, in recent years, displays have included more and more functions, and the structure of the OSD menu has become more and more complicated. In such cases, it has become relatively inconvenient to manipulate the OSD menu by simply using physical buttons of the display. In addition, as the size of the display becomes larger, the distance between the user and the display is gradually increased, and it is inconvenient to perform OSD operations through physical buttons.

### SUMMARY

System and method for displaying On-Screen Display (OSD) navigation by keyboard and mouse are described. In some embodiments, an Information Handling System (IHS) may include a processor and a memory coupled to the processor, the memory having program instructions stored thereon that, upon execution by the processor, cause the IHS to: receive a mouse command from a mouse, and determine that the mouse command is associated with an OSD that is generated by a display. In response to the determination, the instructions generate an OSD-based command that is associated with the mouse command, and transmit the OSD-based command to an OSD controller, wherein the OSD controller is configured to implement at least one setting change of the OSD based on the OSD-based command.

According to another embodiment, a method includes the steps of receiving a mouse command from a mouse, determining that the mouse command is associated with the OSD generated by a display, and in response to the determination: generating an OSD-based command that is associated with the mouse command, and transmitting the OSD-based command to an OSD controller. The OSD controller implements at least one setting change of the OSD based on the OSD-based command, while the OSD displays interactive settings data associated with the display.

According to yet another embodiment, a hardware memory device has program instructions stored thereon that, upon execution by a processor of an IHS, cause the IHS to receive a mouse command from a mouse, and determine that the mouse command is associated with an OSD. In response to the determination, the instructions cause the IHS to generate an OSD-based command that is associated with the mouse command, and transmit the OSD-based command to an OSD controller. The OSD controller is configured to implement at least one setting change of the OSD based on the OSD-based command.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIGS. 1A, 1B, and 1C illustrate an example mouse-based On-Screen Display (OSD) navigation system according to one embodiment of the present disclosure.

FIG. 2 illustrates an example screenshot of a mouse key mapping screen that may be used to configure how the mouse functions with the OSD user interface according to one embodiment of the present disclosure.

FIG. 3 is a block diagram of several components of an example IHS according to one embodiment of the present disclosure.

FIG. 4 illustrates a block diagram view of an example mouse-based OSD navigation system according to one embodiment of the present disclosure.

FIG. 5A illustrates an example mouse-based OSD navigation method that may be performed when the mouse is coupled directly to the display according to one embodiment of the present disclosure.

FIG. 5B illustrates an example OSD user interface configuration update method that may be performed when the mouse is coupled directly to the display according to one embodiment of the present disclosure.

FIG. 6 illustrates a block diagram view of another example mouse-based OSD navigation system according to one embodiment of the present disclosure.

FIG. 7 illustrates another example mouse-based OSD navigation method that may be performed when the mouse is coupled directly to the IHS according to one embodiment of the present disclosure.

### DETAILED DESCRIPTION

Embodiments of the present disclosure provide systems and methods for On-Screen Display (OSD) navigation of a display using a mouse. Whereas traditional manipulation of the OSD of a display was accomplished using physical buttons or knobs that were configured on the display's housing, relatively large displays have heretofore been difficult to manage due in large part, to the ability to quickly change a display setting. Embodiments of the present disclosure provide a solution to this problem, among other problems, by providing a system to receive user input via a readily available User Interface Device (UID), such as a mouse that is easily accessible and manipulating for changing the settings of a display.

Today's monitors support multiple predefined and calibrated settings to meet the needs of different types of applications, such as productivity applications, movie players, reading tools, gaming applications, and the like. Users can access the OSD menu of Displays using physical buttons configured on the Display and navigate the menu to select their preferred display settings. However, as monitor screen sizes have evolving to larger sizes (e.g., greater than 30 inches), accessing the OSD physical buttons to quickly change a display setting has become a problem for those users.

Some conventional implementations provide display OSD software to control the OSD of displays, but this software often needs to be installed on the IHS (e.g., computing device) coupled to the display by the user. Additionally, the display OSD software needs to be continually running the in background in order to provide any realizable benefit. The installed display OSD software usually generates a user interface different from that of the display's OSD, thus requiring an additional learning curve to make use of their features.

Other conventional implementations involve the use of dedicated hardware, such as an external OSD controller that allows a user to change display settings, but this option is often not viable because it may not be cost effective, and when used, requires the user to move their hands from a mouse (which is natively included with most IHS devices), to the OSD controller. Therefore, a simple, easy-use, relatively inexpensive OSD user interface that possesses the same look-and-feel as the display's native OSD menu would provide a benefit to the end-user to enhance their user experience.

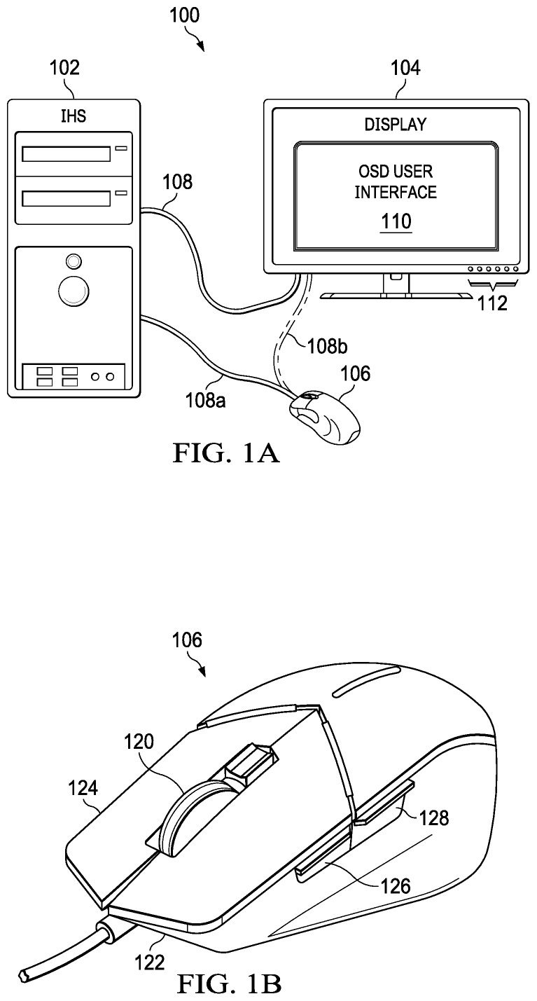

FIGS. 1A, 1B, and 1C illustrate an example mouse-based OSD navigation system 100 according to one embodiment of the present disclosure. In particular, FIG. 1A illustrates an IHS 102, an associated display 104, and a mouse 106 that may be alternatively coupled to either a USB port of the IHS 102 via cabling 108a, or a USB port configured on the display 104 via cabling 108b. As will be described in detail herein below, the system 100 may be configured to use the same mouse 106, which is also used to provide other functions of the IHS 102, to receive user input for adjusting the OSD settings of the display 104. Additionally, the system 100 may provide a technique for customized mapping of the various mouse input mechanisms (e.g., buttons, scroll wheel, control lever, etc.) to the user interface so that the user may select which mouse input mechanisms may be used by the system 100. Although the present embodiment describes a mouse 106 that may be used for adjusting the OSD settings of the display 104, it is contemplated that in other embodiments, other forms of input devices, such as a keyboard or a gamepad may also be used without departing from the spirit and scope of the present disclosure.

In general, the system 100 provides for manipulating the various settings of an OSD user interface 110 generated on the display 104 using a mouse 106, which is typically used to provide user input to the IHS 102 during its normal operation. When the mouse 106 is coupled to the IHS 102 via cabling 108a, the IHS 102 processes any mouse commands directed to the OSD user interface 110 to generate specific commands for manipulating the OSD user interface 110. When the mouse 106 is coupled directly to the display 104 via cabling 108b, the display 104 processes any mouse commands directed to the OSD user interface 110 to generate other specific commands for manipulating the OSD user interface 110. Thus, a device (mouse) that is typically used to operate the IHS 102, may also be used to change the settings of the OSD user interface 110. Such an arrangement alleviates the need to purchase and maintain additional hardware, while providing a common OSD user interface that does not require an additional learning curve to learn how to operate.

In one embodiment, the OSD user interface 110 may be similar in look-and-feel to a OSD user interface that is manipulated using physical buttons 112 configured on the display 104. In some cases, the OSD user interface 110 may be the same OSD user interface that is manipulated by the physical buttons 112 configured on the display 104. In another embodiment, the cabling 108a, 108b may comprise a wired connection (e.g., USB cable) or a wireless connection (e.g., Bluetooth, Wi-Fi, etc.).

With reference now to FIG. 1B, an enlarged view of the mouse 106 of FIG. 1A is shown. The mouse 106 includes a scroll wheel 120, a left button 122, a right button 124, a forward button 126, and a backward button 128. Such input mechanisms are normally included on most mouse devices in current use. In one embodiment, the system 100 maps these input mechanisms (e.g., the scroll wheel 120, left button 122, right button 124, forward button 126, and backward button 128) to function like a joystick to change the settings of the OSD user interface 110. That is, the user can use the mouse input mechanisms to emulate a display monitor OSD joystick function.

A mouse control mode of the OSD user interface 110 may be toggled on and off by a certain mouse action (e.g., long press of scroll wheel), or mouse/keyboard key combination (e.g., ‘F8’ key while simultaneously pressing the scroll wheel). For example, the OSD user interface 110 may be displayed on the display 104 when in mouse control mode, and removed when the mouse control mode is turned off. When in OSD mouse control mode, a USB hub to which the mouse 106 is connected, will capture mouse click events, and process the mouse click events to generate OSD-based commands that may be used to manipulate the settings of the OSD user interface 110.

Referring now to FIG. 1C, an enlarged view of the OSD user interface 110 is shown along with the physical buttons 112 that may also be used to change the settings of the display 104. Continuing the example set forth above, the OSD user interface 110 generally may display a menu that includes one or more categories 132, each having one or more settings 134. When in the mouse control mode, the left button 122, right button 124, forward button 126, and backward button 128 may provide for navigation through the menu. In a particular example, the forward button 126 and backward button 128 may provide for moving up and down among the various categories of the menu, while the left button 122 and right button 124 may provide for moving left and right, respectively, for selecting a particular setting to change. When a particular setting is displayed, the user may accept it by pressing the scroll wheel 120. Additionally, when the user is finished adjusting the settings of the display 104, the aforedescribed sequence may be performed to turn the OSD mouse control mode off.

Referring again to FIG. 1A, the IHS 102 communicates with, and transmits video signals to the display 104 using a video cable 108. Any suitable type of video cable may be used, such as one conforming to a Digital Visual Interface (DVI) standard, a High Definition Multimedia Interface (HDMI) standard, a Mobile High-definition Link (MHL) standard, a RGB standard, a D-SUB standard, and the like that provides a digital signaling channel between the IHS 102 and display 104. In one embodiment, the video cable 108 conforms to the HDMI standard that supports a Display Data Channel (DDC) protocol to enable signaling of OSD-based commands from the IHS 102 to the display 104 for changing the settings as displayed on the OSD user interface 110. In another embodiment, video cable 108 may be replaced or augmented with a wireless connection between IHS 102 and display 104.

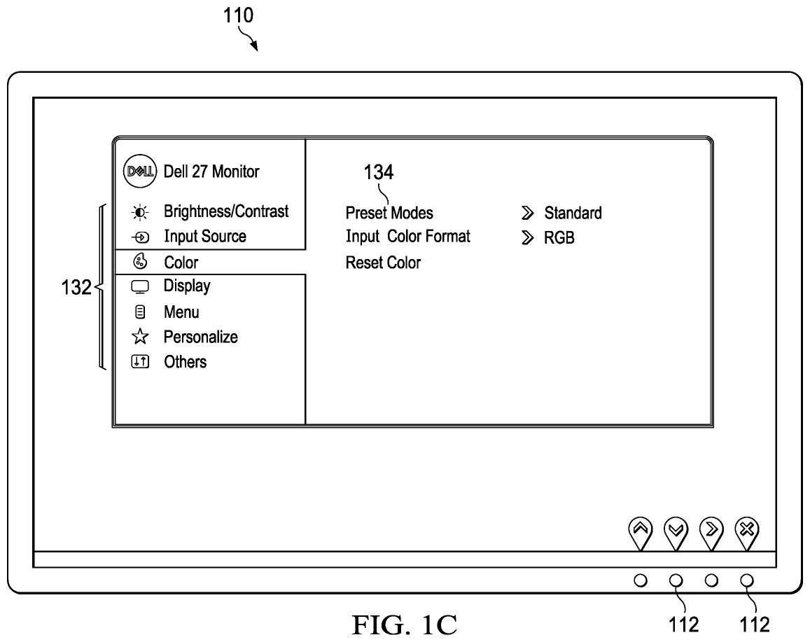

FIG. 2 illustrates an example screenshot of a mouse key mapping screen 200 that may be used to configure how the mouse 106 functions with an OSD user interface 110 according to one embodiment of the present disclosure. As shown, the mouse key mapping screen 200 includes, among other screens, a mouse input mechanism mapping portion 202, and a shortcut key selection portion 204.

Using the mouse input mechanism mapping portion 202, the system 100 receives user input for selecting a particular mapping of the mouse input mechanisms (e.g., scroll wheel, buttons, etc.) to a navigation function of the OSD user interface 110. For example, the system 100 may receive user input for selecting the forward button 126 to move left, and the backward button 128 to move right, while rotating the scroll wheel 120 causes the cursor of the OSD user interface 110 to move up and down.

The shortcut key selection portion 204 enables the system 100 to receive user input for changing certain shortcut keys. In particular, the shortcut key selection portion 204 may include an input switch shortcut key selection field 210 that enables the system 100 to receive user input for selecting a certain mouse action (e.g., long press of scroll wheel), or mouse/keyboard key combination (e.g., ‘F8’ key while simultaneously pressing the scroll wheel) that may be used to enter or leave the OSD mouse control mode. For example, the user may use the input switch shortcut key selection field 210 to change the shortcut key for entering and leaving the OSD mouse control mode from ‘F8’+‘scroll press’ to ‘F9’+‘scroll press’ for some particular reason, such as a conflict that may exist with another application configured on the IHS 102.

The shortcut key selection portion 204 may also include a display setting shortcut key selection field 212 for selecting and/or creating one or more shortcut keys for particular settings of the OSD user interface 110. For example, the system 100 may receive user input for creating a shortcut key (e.g., left button 122+right button 124) that when selected by the user, causes a particular setting to be displayed on the OSD user interface 110, which can be manipulated by the user for changing that setting.

Thus as shown, a mouse that is typically available with an IHS 102 may also be used to manipulate the settings of the OSD user interface 110. Additionally, the assigned input mechanisms of the mouse may be customized according to the needs and desires of the user, particularly when mouses of different makes and models may differ in form and function. The system 100 may also use the same OSD user interface 110, which is also adjustable by physical buttons 112 so that the user may be presented with a common look-and-feel whether the mouse 106 is used or the buttons 112 are used.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

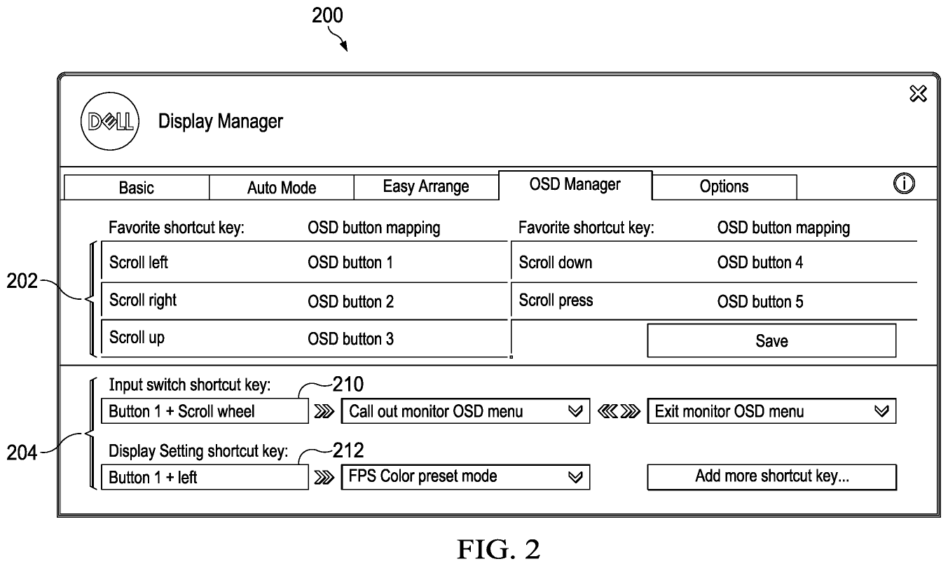

FIG. 3 is a block diagram of several components of an example IHS 300 according to one embodiment of the present disclosure. Particularly, the IHS 102 of FIG. 1A may include certain components of the IHS 300 described herein. The IHS 300 includes one or more processors 301. In various embodiments, IHS 300 may be a single-processor system including one processor 301, or a multi-processor system including two or more processors 301. Processor(s) 301 may include any processor capable of executing program instructions, such as an INTEL PENTIUM series processor or any general-purpose or embedded processors implementing any of a variety of Instruction Set Architectures (ISAs), such as a x86 ISA or a Reduced Instruction Set Computer (RISC) ISA (e.g., POWERPC, ARM, SPARC, MIPS, etc.).

IHS 300 includes chipset 302 that may have one or more integrated circuits coupled to processor(s) 301. In certain embodiments, the chipset 302 may utilize a DMI (Direct Media Interface) or QPI (QuickPath Interconnect) bus 303 for communicating with processor(s) 301.

Chipset 302 provides processor(s) 301 with access to a variety of resources. For instance, chipset 302 provides access to system memory 305 over memory bus 304. System memory 305 may be configured to store program instructions and/or data accessible by processors(s) 301. In various embodiments, system memory 305 may be implemented using any suitable memory technology, such as static RAM (SRAM), synchronous dynamic RAM (SDRAM), nonvolatile/Flash-type memory, or any other type of memory.

Chipset 302 may also provide access to graphics processor 307. In certain embodiments, graphics processor 307 may be part of one or more video or graphics cards that have been installed as components of IHS 300. Graphics processor 307 may be coupled to chipset 302 via graphics bus 306 such as provided by an Accelerated Graphics Port (AGP) bus, or a Peripheral Component Interconnect Express (PCIe) bus. In certain embodiments, graphics processor 307 generates display signals and provides them to display device 308. In certain embodiments, display device 308 may be a touch-sensitive display.

In some implementations, chipset 302 may also provide access to one or more user input devices 311. For instance, chipset 302 may be coupled to a User Input Device (UID) controller 310 or an embedded controller (EC) via eSPI (Enhanced Serial Peripheral Interface) or Low-Pin Count (LPC) bus 313, and UID controller 310 may provide interfaces for a variety of user input devices 311 (e.g., lower bandwidth and low data rate devices). Particularly, UID controller 310 may provide access to the mouse 106, a keyboard, or other peripheral input devices such as keypads, gamepads, biometric scanning devices, and voice or optical recognition devices.

Other resources may also be coupled to processor(s) 301 of IHS 300 through chipset 302. For example, chipset 302 may be coupled to network interface 309, such as a Network Interface Controller (NIC). In certain embodiments, network interface 309 may be coupled to chipset 302 via a PCIe bus. Network interface 309 may support communication via various wired and/or wireless networks.

Chipset 302 may also provide access to one or more hard disk and/or solid state drives 315. In certain embodiments, chipset 302 may also provide access to one or more optical drives 314 or other removable-media drives. Any or all of drive devices 314 and 315 may be integral to IHS 300, or they may be located remotely. Chipset 302 may also provide access to one or more Universal Serial Bus (USB) ports 316.

In certain implementations, chipset IHS 302 may support an I²C (Inter-Integrated Circuit) bus that may be used to communicate with various types of microcontrollers, microprocessor and integrated circuits that are typically integrated components of the motherboard of the IHS 300 and perform specialized operations. For example, such an I²C bus may be utilized to transmit and receive keystroke and hovering keystroke information from an attached keyboard device, and to provide that information to an operating system (OS) executed by IHS 300.

Another resource that may be accessed by processor(s) 301 via chipset 302 is Basic Input/Output System (BIOS) 317. Upon booting of IHS 300, processor(s) 301 may utilize BIOS 317 instructions to initialize and test hardware components coupled to IHS 300 and to load an OS for use by IHS 300. BIOS 317 provides an abstraction layer that allows the OS to interface with certain hardware components that are utilized by IHS 300. The Unified Extensible Firmware Interface (UEFI) was designed as a successor to BIOS; many modern IHSs utilize UEFI in addition to or instead of a BIOS. As used herein, BIOS is also intended to encompass UEFI.

Chipset 302 may also provide an interface for communications with one or more sensors (not shown). The sensors may be disposed within the display 104, or other component of the IHS 300, and may include, but are not limited to: electric, magnetic, radio, optical, infrared, thermal, force, pressure, acoustic, ultrasonic, proximity, position, deformation, bending, direction, movement, velocity, gyroscope, rotation, and/or acceleration sensor(s).

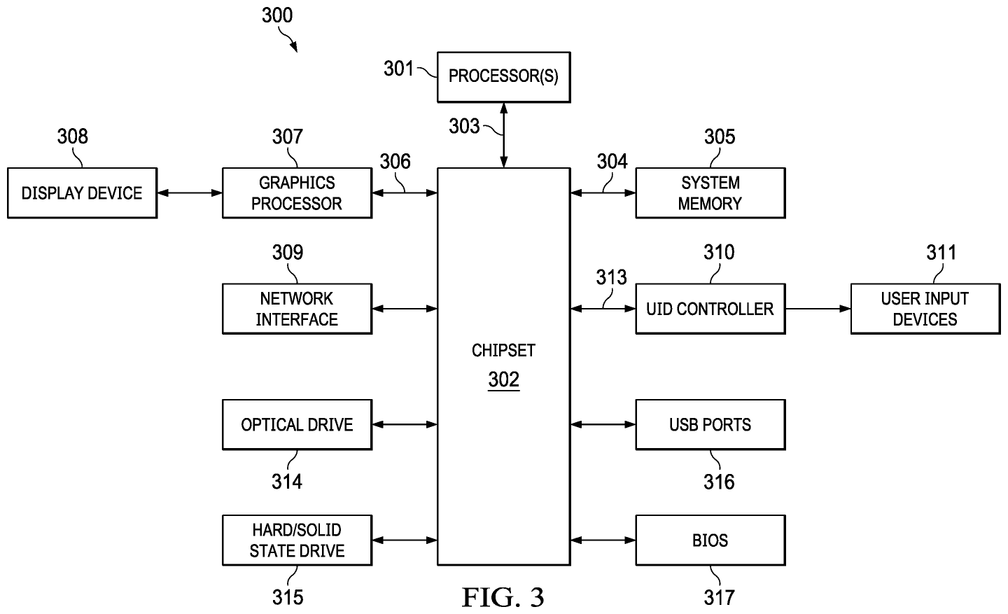

FIG. 4 illustrates a block diagram view of an example mouse-based OSD navigation system 400 according to one embodiment of the present disclosure. In this embodiment, the monitor 104 includes a USB hub 402, a UID sniffer 404, a scalar 408, a video port 410, and an OSD menu controller 406, while the IHS 102 includes a display manager 420 and a video port 422. Such an arrangement may be used when the mouse 106 is coupled to, and manages the OSD user interface 110 through the display 104.

The display manager 420 receives user input via the OSD user interface 110 to manage operation of the display 104. The display manager 420 is executed by the Operating System (OS) of the IHS 102, and is continually running as a process in the background while the OS is operating. One example display manager 420 may include at least a portion of a Dell Display Manager (DDM) available from DELL TECHNOLOGIES. The Dell Display Manager enhances everyday productivity through comprehensive management tools that are available from the IHS 102, which provide optimal front of screen experience, efficient display management, and easy, effortless multitasking. Using the Dell Display Manager, users may be enabled to manage and control displays remotely from where the display is located. In general, the display manager may be used in the embodiment of FIG. 4 to adjust or update the configuration of the OSD user interface 110 from the IHS 102. For example, the display manager 420 may generate the mouse key mapping screen 200 as described above with reference to FIG. 2 in which the mouse key mapping screen 200 may be used to configure how the mouse 106 functions with the OSD user interface 110.

The OSD menu controller 406 generally comprises an executable process that includes instructions stored in a memory and executed by at least processor configured in the display 104. The OSD menu controller 406 manages the operation of the OSD user interface 110 to receive user input from a user for navigating through the menu of the OSD user interface 110 and controlling the operation of the display 104. To provide a specific example, the OSD menu controller 406 may communicate with the display manager 420 via the video ports 410, 422 configured on the display 104 and IHS 102, respectively. In one embodiment, the video ports 410, 422 are coupled together, and provide communication using a Display Data Channel (DDC) protocol over a High Definition Media Interface (HDMI) physical interface. Nevertheless, it should be appreciated that the OSD menu controller 406 may communicate with the display manager 420 using any suitable communication protocol, and physical interface without departing from the spirit and scope of the present disclosure.

The UID sniffer 404 generally comprises an executable process that includes instructions stored in a memory and executed by at least processor configured in the display 104. The UID sniffer 404 communicates with the USB hub 402 to receive user input from the mouse 106, and when an OSD user interface-based user input is received, converting the mouse commands into a format suitable for use by the OSD menu controller 406, and sending the formatted commands to the scalar 408 using an I²C bus in which the scalar 408 decodes and sends the formatted commands to het OSD menu controller 406 to execute the OSD menu function. That is, the UID sniffer 404 continually monitors mouse-based commands received from the USB hub 402, and when it detects that any of those commands is directed to the OSD user interface 110, convert the mouse commands into OSD-based commands, which are then forwarded to the OSD menu controller 406. The USB hub 402 generally provides a physical interface for a mouse with a USB interface. The USB hub 402 may include, for example, a USB port (e.g., physical interface), and a USB driver (e.g., executable software) that is executed on the display 104 for interfacing the USB port with various executable processes running on the display 104.

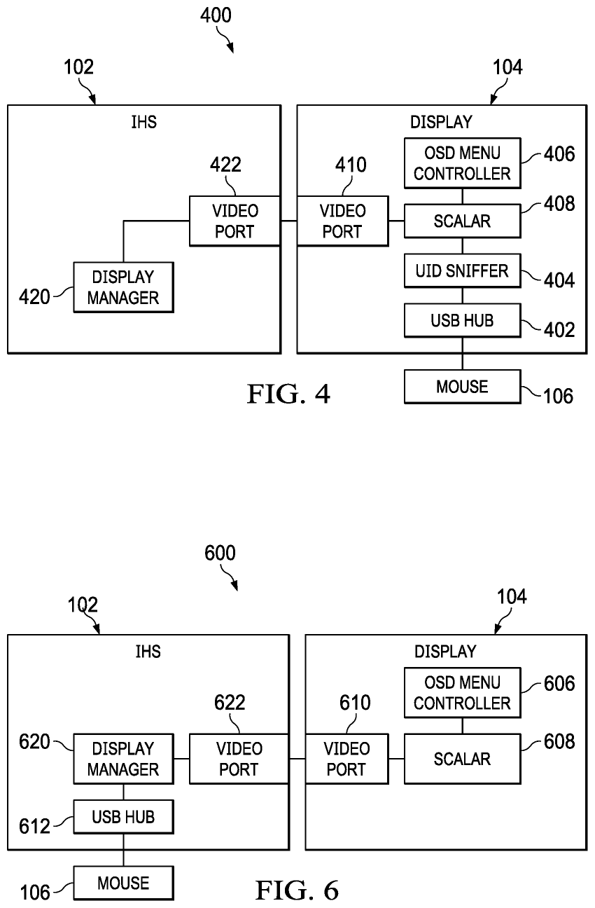

FIG. 5A illustrates an example mouse-based OSD navigation method 500 that may be performed when the mouse 106 is coupled directly to the display 104 according to one embodiment of the present disclosure. In some embodiments, at least a portion of the steps of the method 500 may be performed by the system 400 of FIG. 4 in response to the execution of program instructions stored in a hardware memory.

At step 502, the USB hub 402 receives user input from mouse and sends the received user input to the UID sniffer 404. In one embodiment, the USB hub 402 may be one that is configured within the housing of the display. In another embodiment, the USB hub 402 may be one having a USB driver that communicates with other processes of the display 104 through a bus of the display 104 and/or a local communication link (e.g., I2C bus) configured in the display 104. Thereafter at 504, the UID sniffer 404 determines whether any received input is OSD-based. That is, the UID sniffer 404 continually monitors commands received from the mouse 106 to determine if any should be directed to the OSD user interface 110. If so, processing continues at step 506; otherwise, processing continues at step 502 to continually monitor commands received from the mouse 106.

At step 506, the UID sniffer 404 converts mouse commands to OSD-based commands. Thereafter at step 508, the UID sniffer 404 transmits the OSD-based commands to scalar 408. The scalar 408 triggers OSD function and decodes OSD based commands to OSD menu controller 406 at step 510, and at step 512, OSD menu controller 406 navigates menu according to OSD-based commands. At this point, the settings have been successfully changed by the mouse 106 connected directly to the display 104.

The method 500 may be repeatedly performed for continually updating or changing the settings of the display 104 using a mouse 106 directly coupled to the display 104. Nevertheless, when use of the method 500 is no longer needed or desired, the process ends.

FIG. 5B illustrates an example OSD user interface configuration update method 550 that may be performed when the mouse 106 is coupled directly to the display 104 according to one embodiment of the present disclosure. In some embodiments, at least a portion of the steps of the method 550 may be performed by the system 400 of FIG. 4 in response to the execution of program instructions stored in a hardware memory.

At step 552, the display manager 420 receives user input for updating a configuration of the OSD user interface 110 of a display 104. For example, the display manager 420 may receive one or more user input actions to change or adjust the settings of the display 104 using input devices, such as a keyboard, a second mouse connected directly to the IHS 102, and the like. Example configurations that may be updated include a mouse input mechanism to OSD user interface mapping scheme (a “mouse-to-OSD mapping scheme”), input switch shortcut keys, display setting shortcut keys, and the like.

Thereafter at step 554, when a setting is selected by the user, the display manager 420 communicates with the UID sniffer 404 to update how the mouse commands are to be interpreted by the UID sniffer 404. For example, the UID sniffer 404 may include a mapping table that stores information about which input mechanisms of the mouse 106 are to be associated with certain actions of the OSD user interface 110. In one embodiment, the display manager 420 may communicate with the UID sniffer 404 through the video cable (e.g., HDMI cable) that conveys video signals from the IHS 102 to the display 104. In another embodiment, the display manager 420 communicates with the UID sniffer 404 using a DDC protocol over the video cable. Nevertheless, when step 554 has been completed the process ends. It may be important to note that the OSD user interface configuration update method 550 may be performed whether the mouse 106 is directly coupled to the display 104 or the IHS 102.

Although FIGS. 5A and 5B describe example methods 500, 550 that may be performed to manipulate an OSD user interface 110 using a mouse directly coupled to the display 104, the features of the methods 500, 550 may be embodied in other specific forms without deviating from the spirit and scope of the present disclosure. For example, the methods 500, 550 may perform additional, fewer, or different operations than those described in the present examples. As another example, certain steps of the aforedescribed methods 500, 550 may be performed in a sequence different from that described above. As yet another example, certain steps of the methods 500, 550 may be performed by other components in the IHS 102 other than those described above.

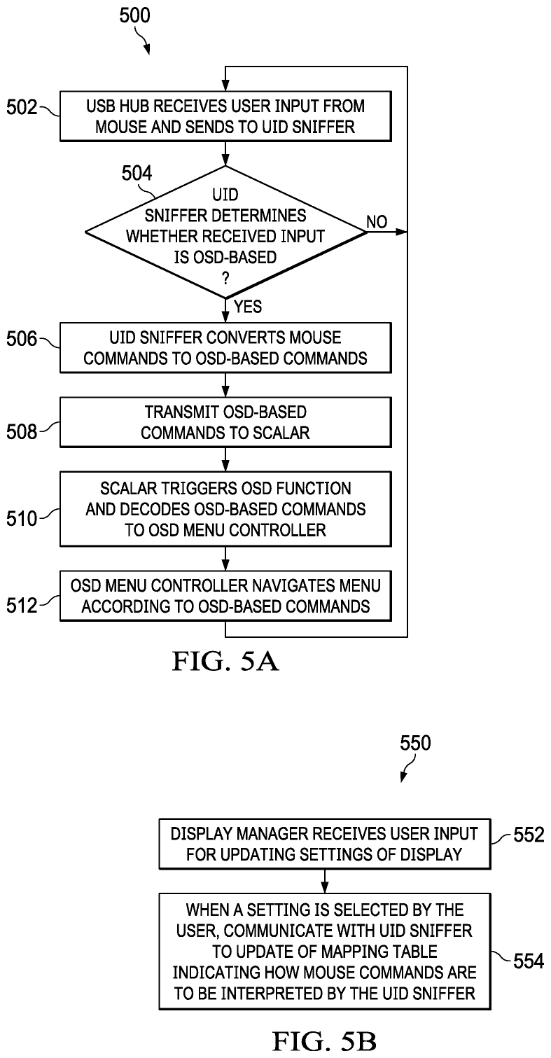

FIG. 6 illustrates a block diagram view of another example mouse-based OSD navigation system according to one embodiment of the present disclosure. In this particular embodiment, the display 104 includes an OSD menu controller 606, a scalar 608, a video port 610, while the IHS 102 includes a USB hub 612, a display manager 620 and a video port 622. Such an arrangement may be used when the mouse 106 is coupled directly to the IHS 102, and manages the OSD user interface 110 via the display manager 620 configured in the IHS 102. Although the present embodiment is described with certain components as shown, it should be appreciated that either of the IHS 102 and/or display 104 may possess additional, fewer, or different components without departing from the spirit and scope of the present disclosure. For example, it is contemplated that each of the IHS 102 and display 104 may possess the components as shown in FIGS. 4 and 6 so that the mouse 106 may be directly coupled to either of the IHS 102 or display 104 for managing the operations of the OSD user interface 110 as described above with reference to FIGS. 1A-1C.

The display manager 620, video ports 610, 622, OSD menu controller 606, scalar 608, and UID sniffer 604 are similar in design and construction to the display manager 420, video ports 410, 422, OSD menu controller 406, scalar 408, and UID sniffer 404. The difference, however, is that the IHS 102 includes a USB hub 402 for, among other things, direct connection of the mouse 106 to the IHS 102.

The display manager 620 is started when the IHS 102 is booted and is executed continually as the IHS 102 is operating. In one aspect, the display manager 620 functions as a sniffer to continually monitor for mouse commands to determine if/when any are associated with the OSD user interface 110. Essentially, the display manager 620 functions as a sniffer to detect mouse commands that may be directed to the OSD user interface 110. When any mouse commands are received, the display manager 620 forwards them to the scalar 608 for processing. In one embodiment, the mouse commands are forwarded to the scalar 608 through the video ports 610, 622 using a DDC protocol.

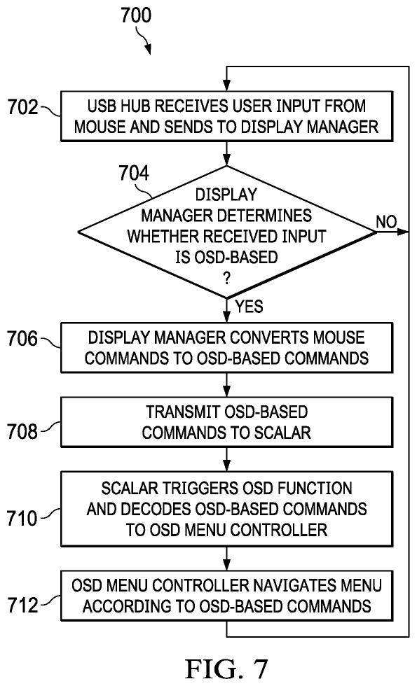

FIG. 7 illustrates another example mouse-based OSD navigation method 700 that may be performed when the mouse 106 is coupled directly to the IHS 102 according to one embodiment of the present disclosure. In some embodiments, at least a portion of the steps of the method 700 may be performed by the system 600 of FIG. 6 in response to the execution of program instructions stored in a hardware memory.

At step 702, the USB hub 612 receives user input from mouse and sends the received user input to the display manager 620. In one embodiment, the USB hub 612 may be one that is configured within the housing of the IHS 102. Thereafter at 704, the display manager 620 determines whether any received input is OSD-based. That is, the display manager 620 continually monitors commands received from the mouse 106 to determine if any should be directed to the OSD user interface 110. If so, processing continues at step 706; otherwise, processing continues at step 702 to continually monitor commands received from the mouse 106.

At step 706, the display manager 620 converts the mouse commands to OSD-based commands. Thereafter at step 708, the display manager 620 transmits the OSD-based commands to the scalar 608 in which the scalar 608 decodes the commands to the OSD menu controller 606 to execute the OSD menu function. The scalar 608 triggers OSD function and decodes OSD based commands to OSD menu controller 606 at step 710, and at step 712, OSD menu controller 606 navigates menu according to OSD-based commands. At this point, the settings have been successfully changed by the mouse 106, which is connected directly to the IHS 102.

The method 700 may be repeatedly performed for continually updating or changing the settings of the display 104 using a mouse 106 directly coupled to the IHS 102. Nevertheless, when use of the method 700 is no longer needed or desired, the process ends.

Although FIG. 7 describes an example method 700 that may be performed to manipulate an OSD user interface 110 using a mouse directly coupled to an IHS 102, the features of the method 700 may be embodied in other specific forms without deviating from the spirit and scope of the present disclosure. For example, the method 700 may perform additional, fewer, or different operations than those described in the present examples. As another example, certain steps of the aforedescribed method 700 may be performed in a sequence different from that described above. As yet another example, certain steps of the method 700 may be performed by other components in the IHS 102 other than those described above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An On-Screen Display (OSD) navigation system, comprising:
a display configured to generate an OSD that displays interactive settings data associated with the display;
a sniffer to convert mouse commands to OSD-based commands, wherein the sniffer is configured in the display;
a processor configured in the display; and
a memory device configured in the display and coupled to the processor, the memory device having instructions stored thereon that, upon execution by the processor, cause the processor to:
receive a mouse command from a mouse directly coupled to an input port of the display;
determine, using the sniffer, that the mouse command is associated with the OSD, wherein the mouse communicates directly with the sniffer without any intervention from a computing device that is configured to use the display; and
in response to the determination:
generate an OSD-based command that is associated with the mouse command; and
transmit the OSD-based command to an OSD controller, wherein the OSD controller is configured to implement at least one setting change of the OSD based on the OSD-based command.

2. (canceled)

3. The OSD navigation system of claim 1, wherein the instructions, upon execution, further cause the processor to monitor the input port for mouse commands, and generate the OSD-based command only when the mouse command is associated with the OSD.

4. The OSD navigation system of claim 1, wherein the instructions, upon execution, further cause the processor to receive the mouse command from a mouse coupled to an Information Handling System (IHS).

5. The OSD navigation system of claim 4, wherein the instructions, upon execution, further cause the processor to transmit the OSD-based command to the OSD controller through a video cable that conveys a video signal from the IHS to the display.

6. The OSD navigation system of claim 1, wherein the instructions, upon execution, further cause the processor to generate the OSD-based command according to a mouse-to-OSD mapping scheme that converts mouse input mechanisms into a format suitable for use by the OSD controller.

7. The OSD navigation system of claim 6, wherein the input mechanisms comprise at least one of: a mouse button, a scroll wheel, or a control lever.

8. The OSD navigation system of claim 6, wherein the instructions, upon execution, further cause the processor to customize the mouse-to-OSD mapping scheme by changing which input mechanism of a mouse is used to perform a particular OSD action.

9. The OSD navigation system of claim 1, wherein the instructions, upon execution, further cause the processor to receive the mouse command from an input device comprising at least one of: a wired mouse, a wireless mouse, a gamepad, or a keyboard.

10. The OSD navigation system of claim 1, wherein the instructions, upon execution, further cause the processor to implement at least one setting change of the OSD using a scalar device of the display.

11. An On-Screen Display (OSD) navigation method, comprising:
receiving, by a display, a mouse command from a mouse directly coupled to an input port of the display;
determining, using a sniffer, that the mouse command is associated with an OSD generated by the display, wherein the OSD displays interactive settings data associated with the display, wherein the mouse communicates directly with the sniffer without any intervention from a computing device that is configured to use the display; and
in response to the determination:
generating, by the display, an OSD-based command that is associated with the mouse command; and
transmitting, by the display, the OSD-based command to an OSD controller, wherein the OSD controller implements at least one setting change of the OSD based on the OSD-based command.

12. (canceled)

13. The OSD navigation method of claim 11, further comprising receiving the mouse command from a mouse coupled to the input port configured in an Information Handling System (IHS), and transmitting the OSD-based command to the OSD controller through a video cable that conveys a video signal from the IHS to the display.

14. The OSD navigation method of claim 11, further comprising generating the OSD-based command according to a mouse-to-OSD mapping scheme that converts mouse input mechanisms into a format suitable for use by the OSD controller.

15. The OSD navigation method of claim 14, further comprising customizing the mouse-to-OSD mapping scheme by changing which input mechanism of the mouse is used to perform a particular OSD action.

16. The OSD navigation method of claim 11, further comprising performing at least one setting change of the OSD using a scalar device configured in the display.

17. A hardware memory device having program instructions stored thereon that, upon execution by a processor of a display, cause the processor to:
receive, using the display, a mouse command from a mouse directly coupled to an input port of the display;
determine, using a sniffer, that the mouse command is associated with an On-Screen Display (OSD), wherein the OSD displays interactive settings associated with the display, wherein the mouse communicates directly with the sniffer without any intervention from a computing device that is configured to use the display; and
in response to the determination:
generate, using the display, an OSD-based command associated with the mouse command; and
transmit, using the display, the OSD-based command to an OSD controller, wherein the OSD controller is configured to implement at least one setting change of the OSD based on the OSD-based command.

18. The OSD navigation system of claim 17, wherein the instructions, upon execution, further cause the processor to monitor the input port for mouse commands, and generate the OSD-based command only when the mouse command is associated with the OSD.

19. The OSD navigation system of claim 17, wherein the instructions, upon execution, further cause the processor to receive the mouse command from a mouse when coupled to a USB hub coupled to an Information Handling System (IHS), and transmit the OSD-based command to the OSD controller through a video connection that conveys a video signal from the IHS to the display.

20. The OSD navigation system of claim 17, wherein the instructions, upon execution, further cause the processor to generate the OSD-based command according to a mouse-to-OSD mapping scheme that converts mouse input mechanisms into a format suitable for use by the OSD controller, and customize the mouse-to-OSD mapping scheme by changing which input mechanism is used to perform a particular OSD action.
